(19) United States
(12) Patent Application Publication
(10) Pub. No.: US 2009/0245429 A1
(43) Pub. Date: Oct. 1, 2009

(54) SAMPLE RATE CONVERTER AND RECEIVER USING THE SAME

(75) Inventors: Masanori FURUTA, Mishima-shi (JP); Takafumi Yamaji, Yokohama-shi (JP); Takeshi Ueno, Kawasaki-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Kabushiki Kaisha Toshiba

(21) Appl. No.: 12/399,239

(22) Filed: Mar. 6, 2009

(30) Foreign Application Priority Data
Mar. 25, 2008 (JP) 2008-078744

(51) Int. Cl. H04L 27/06; H04L 7/00

(52) U.S. Cl. 375/340; 375/355

(57) ABSTRACT

A sample rate converter includes a multiplexer which multiplexes input signals, an interpolator which interpolates a multiplexed output signal to generate a first feedback signal, a multiplier which multiplies the first feedback signal by a coefficient, a subtracter which subtracts the multiplied signal from the multiplexed input signal, an adder which adds the residual signal and a second feedback signal to sequentially generate integrated signals corresponding to the input signals, respectively, a register circuit configured to individually hold integrated signals, a multiplexer which multiplexes the integrated signals from the register circuit to generate the second feedback signal, a multiplexer which multiplexes the integrated signals from the register circuit to generate a decimation target signal, a decimator which subjects the decimation target signal to decimation to generate the multiplexed output signal, and a discrimination circuit configured to discriminate the multiplexed output signal to generate output signals.

### CROSS-REFERENCE TO RELATED APPLICATIONS

This application is based upon and claims the benefit of priority from prior Japanese Patent Application No. 2008-078744, filed Mar. 25, 2008, the entire contents of which are incorporated herein by reference.

### BACKGROUND OF THE INVENTION

1. Field of the Invention

The present invention relates to a sample rate converter for converting the sample rate of a plurality of input signals, and to a receiver using the converter.

2. Description of the Related Art

In general, if a high-rate digital signal output from an A/D converter is downsampled by a sample rate converter, a folding noise may be generated in a desired signal band. Such folding noise leads to deterioration of a signal-to-noise ratio (SNR). Therefore, it has heretofore been the case that the folding noise is suppressed by a high phase linearity filter such as a sinc-type filter before the downsampling.

In a receiver in a radio communication system, an oversampling type A/D converter is often used for analog-to-digital conversion of I (In-phase) channel and Q (Quadrature-phase) channel signals. A receiver described in JP-A H9-191253 (KOKAI) has individual oversampling type A/D converters for an I channel and a Q channel, and each of the oversampling type A/D converters has a sample rate converter. The sample rate converters in the receiver described in JP-A H9-191253 (KOKAI) downsample signals from which folding noise has been suppressed, and can therefore inhibit the deterioration of the SNR.

When the sample rate of a plurality of input signals with different phases is converted as in the receiver described in JP-A H9-191253 (KOKAI), a sample rate converter is required for each of the input signals. For example, when the sample rate of I/Q channel signals is converted, two sample rate converters are required. Likewise, when the number of input signals are three or more, sample rate converters as many as these input signals are required. Therefore, the problem of the conventional sample rate converter is that the circuit area and power consumption increase in proportion to the number of input signals.

### BRIEF SUMMARY OF THE INVENTION

According to an aspect of the invention, there is provided a sample rate converter which converts a sample rate of a plurality of input signals to generate a plurality of output signals, comprising: a first multiplexer which sequentially selects the plurality of input signals within a cycle corresponding to the sample rate and multiplexes the input signals to obtain a multiplexed input signal; an interpolator which interpolates a multiplexed output signal in accordance with a decimation rate to generate a first feedback signal; a multiplier which multiplies the first feedback signal by a coefficient to generate a multiplied signal; a subtracter which subtracts the multiplied signal from the multiplexed input signal to generate a residual signal; an adder which adds the residual signal and a second feedback signal to sequentially generate a plurality of integrated signals corresponding to the plurality of input signals, respectively; a register circuit configured to individually hold the plurality of integrated signals; a second multiplexer which sequentially selects the integrated signals from the register circuit and multiplexes the integrated signals to generate the second feedback signal; a third multiplexer which sequentially selects the integrated signals from the register circuit and multiplexes the integrated signals to generate a decimation target signal; a decimator which subjects the decimation target signal to decimation in accordance with the decimation rate to generate the multiplexed output signal; and a discrimination circuit configured to discriminate the multiplexed output signal to generate the plurality of output signals.

According to another aspect of the invention, there is provided a sample rate converter which converts a sample rate of a plurality of input signals to generate a plurality of output signals, comprising: a multiplexer which sequentially selects the plurality of input signals within a cycle corresponding to the sample rate and multiplexes the input signals to obtain a multiplexed input signal; an interpolator which interpolates a multiplexed output signal in accordance with a decimation rate to generate a feedback signal; a multiplier which multiplies the feedback signal by a coefficient to generate a multiplied signal; a subtracter which subtracts the multiplied signal from the multiplexed input signal to generate a residual signal; an adder which adds the residual signal and the multiplexed output signal to sequentially generate a plurality of integrated signals corresponding to the plurality of input signals, respectively; a shift register circuit configured to hold the integrated signals and take the integrated signals out as the multiplexed output signal after the cycle has passed; and an output discrimination circuit configured to discriminate the multiplexed output signal to generate the plurality of output signals.

According to another aspect of the invention, there is provided a sample rate converter which converts a sample rate of a plurality of input signals to generate a plurality of output signals, comprising: a first multiplexer which sequentially selects the plurality of input signals within a cycle corresponding to the sample rate and multiplexes the input signals to obtain a multiplexed input signal; an interpolator which interpolates a multiplexed output signal in accordance with a decimation rate to generate a feedback signal; a multiplier which multiplies the feedback signal by a coefficient to generate a multiplied signal; a subtracter which subtracts the multiplied signal from the multiplexed input signal to generate a residual signal; an adder which adds the residual signal and the multiplexed output signal to sequentially generate a plurality of integrated signals corresponding to the plurality of input signals, respectively; a register circuit configured to individually hold the plurality of integrated signals; a second multiplexer which sequentially selects the integrated signals from the register circuit and multiplexes the integrated signals to generate the multiplexed output signal; and an output discrimination circuit configured to discriminate the multiplexed output signal to generate the plurality of output signals.

### BRIEF DESCRIPTION OF THE SEVERAL VIEWS OF THE DRAWING

FIG. 1 is a block diagram showing a sample rate converter according to a first embodiment;

FIG. 2 is a view showing one example of a timing chart of various signals processed by the sample rate converter in FIG. 1;

FIG. 3 is a block diagram showing a sample rate converter according to a second embodiment;

FIG. 4 is a view showing one example of a timing chart of various signals processed by the sample rate converter in FIG. 3;

FIG. 5 is a block diagram showing a sample rate converter according to a third embodiment;

FIG. 6 is a view showing one example of a timing chart of various signals processed by the sample rate converter in FIG. 5;

FIG. 7 is a block diagram showing a sample rate converter according to a fourth embodiment;

FIG. 8 is a block diagram showing a sample rate converter according to a fifth embodiment;

FIG. 9 is a block diagram showing a sample rate converter according to a sixth embodiment;

FIG. 10 is a view showing one example of multiplier coefficients K provided to multipliers in FIGS. 7, 8 and 9; and

FIG. 11 is a block diagram showing a receiver according to a seventh embodiment.

### DETAILED DESCRIPTION OF THE INVENTION

Hereinafter, embodiments of the present invention will be described with reference to the drawings.

### First Embodiment

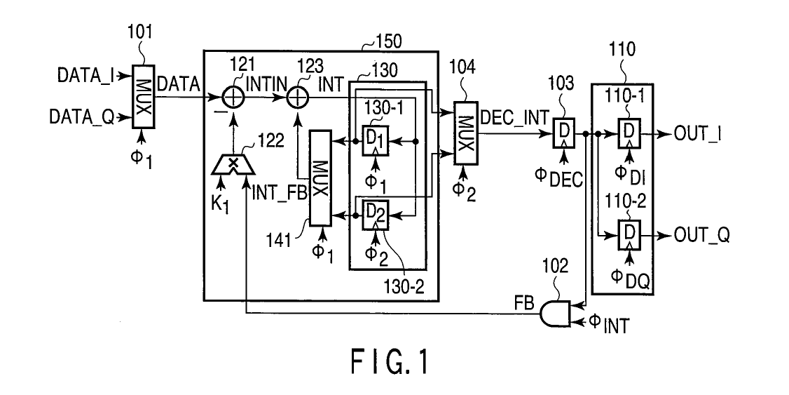

As shown in FIG. 1, a sample rate converter according to a first embodiment of the invention has a multiplexer 101, an interpolator 102, a decimator 103, a multiplexer 104, an output discrimination circuit 110 and a loop filter 150. The sample rate converter in FIG. 1 performs decimation to multiply the sample rate of input signals on I and Q channels (on two channels) 1/D times. The loop filter 150 is a 1st-order sinc-filter for suppressing folding noise, and includes a subtracter 121, a multiplier 122, an adder 123, a register circuit 130 and a multiplexer 141.

The multiplexer 101 selects either an input signal DATA_I or an input signal DATA_Q, and inputs the selected input signal DATA to the subtracter 121. Specifically, the multiplexer 101 selects the input signal DATA_I as the selected input signal DATA if a control clock φ1 having the same sample rate as the input signals DATA_I and DATA_Q is “0”. On the other hand, the multiplexer 101 selects the input signal DATA_Q as the selected input signal DATA if the control clock φ1 is “1”. Here, the input signal DATA_I and the input signal DATA_Q are what is called an I-channel signal and a Q-channel signal, and are different from each other by 180 degrees in phase.

The multiplier 122 multiplies a feedback signal FB from the interpolator 102, described later, by a predetermined multiplier coefficient K1, and inputs the result of the multiplication to the subtracter 121. In addition, the multiplier coefficient K1 is determined by a decimation rate D of the sample rate converter in FIG. 1.

The subtracter 121 subtracts the multiplication result from the multiplier 122, from the selected input signal DATA from the multiplexer 101. That is, the subtracter 121 subtracts the feedback signal FB multiplied K1 in the multiplier 122 from the selected input signal DATA. The subtracter 121 inputs the result of the subtraction to the adder 123 as an integrator input signal INTIN. The adder 123 performs integration by adding the integrator input signal INTIN from the subtracter 121 to an integrator feedback signal INT_FB from the multiplexer 141 described later. The adder 123 inputs the result of the addition to the register circuit 130 as an integrated signal INT. Here, the integrator feedback signal INT_FB is a previous (one cycle before) integrated signal INT.

The register circuit 130 includes a flip-flop 130-1 for temporarily holding the integrated signal INT associated with the DATA_I, and a flip-flop 130-2 for temporarily holding the integrated signal INT associated with the DATA_Q. Specifically, the flip-flop 130-1 is what is called a positive edge triggered D flip-flop controlled by the control clock φ1, and makes the transition into a latched state in accordance with the rising edge of the control clock φ1 to hold the input signal and output this signal until the next rising edge. On the other hand, the flip-flop 130-2 is controlled by a control clock φ2 equal to the control clock φ1 in sample rate and differs by 180 degrees in phase from the control clock φ1. In addition, in the following explanation, the flip-flops are positive edge triggered D flip-flops unless otherwise specified.

The integrated signal INT from the adder 123 is commonly input to the flip-flop 130-1 and the flip-flop 130-2. At the rising of the control clock φ1, the integrated signal INT associated with the DATA_I is input to the register circuit 130, and the flip-flop 130-1 holds this integrated signal INT. Then, the flip-flop 130-1 inputs this integrated signal INT to the multiplexer 141 and the multiplexer 104 until the next rising edge of the control clock φ1. On the other hand, at the rising of the control clock φ2, the integrated signal INT associated with the DATA_Q is input to the register circuit 130, and flip-flop 130-2 holds this integrated signal INT. Then, the flip-flop 130-2 inputs this integrated signal INT to the multiplexer 141 and the multiplexer 104 until the next rising edge of the control clock φ2.

The multiplexer 141 selects one of the signals (held contents) from the flip-flop 130-1 and the flip-flop 130-2 in the register circuit 130, and inputs the selected signal to the adder 123 as the above-mentioned integrator feedback signal INT_FB. Specifically, the multiplexer 141 selects the signal from the flip-flop 130-1 as the integrator feedback signal INT_FB if the control clock φ2 is “1”. On the other hand, the multiplexer 141 selects the signal from the flip-flop 130-2 as the integrator feedback signal INT_FB if the control clock φ2 is “0”.

The multiplexer 104 selects one of the signals from the flip-flop 130-1 and the flip-flop 130-2 in the register circuit 130, and inputs the selected signal to the decimator 103 as a decimator input signal DEC_INT. Specifically, the multiplexer 104 selects the signal from the flip-flop 130-1 as the decimator input signal DEC_INT if the control clock φ2 is “1”. On the other hand, the multiplexer 104 selects the signal from the flip-flop 130-2 as the decimator input signal DEC_INT if the control clock φ2 is “0”.

The decimator 103 is a flip-flop controlled by a control clock φDEC, and operates as a decimator with the decimation rate D. That is, the decimator 103 performs thinning decimation so that the sampling number of the decimator input signals DEC_INT from the multiplexer 104 may be 1/D times. The decimator 103 inputs the result of the decimation to the output discrimination circuit 110 and the interpolator 102 as a decimator output signal.

The interpolator 102 performs interpolation in which “0” is inserted so that the sampling number of the decimator output signals from the decimator 103 may be D times. Specifically, the interpolator 102 performs an AND operation between a control clock φINT having a sampling rate 1/D times as high as that of the control clock φ1 and the control clock φ2, and the decimator output signal, and the interpolator 102 then inputs the result of the operation to the multiplier 122 as the feedback signal FB.

The output discrimination circuit 110 includes a flip-flop 110-1 for discriminating an output signal OUT_I associated with the DATA_I, and a flip-flop 110-2 for discriminating an output signal OUT_Q associated with the DATA_Q.

The decimator output signal from the decimator 103 is commonly input to the flip-flop 110-1 and the flip-flop 110-2. The output signal OUT_I and the output signal OUT_Q are time-divisionally multiplexed in the decimator output signal. The flip-flop 110-1 is controlled by a control clock φDI, and the flip-flop 110-2 is controlled by a control clock φDQ.

At the rising of the control clock φDI, the decimator output signal associated with the DATA_I is input to the output discrimination circuit 110, and the flip-flop 110-1 holds this decimator output signal and outputs it as the output signal OUT_I. On the other hand, at the rising of the control clock φDQ, the decimator output signal associated with the DATA_Q is input to the output discrimination circuit 110, and the flip-flop 110-2 holds this decimator output signal and outputs it as the output signal OUT_Q.

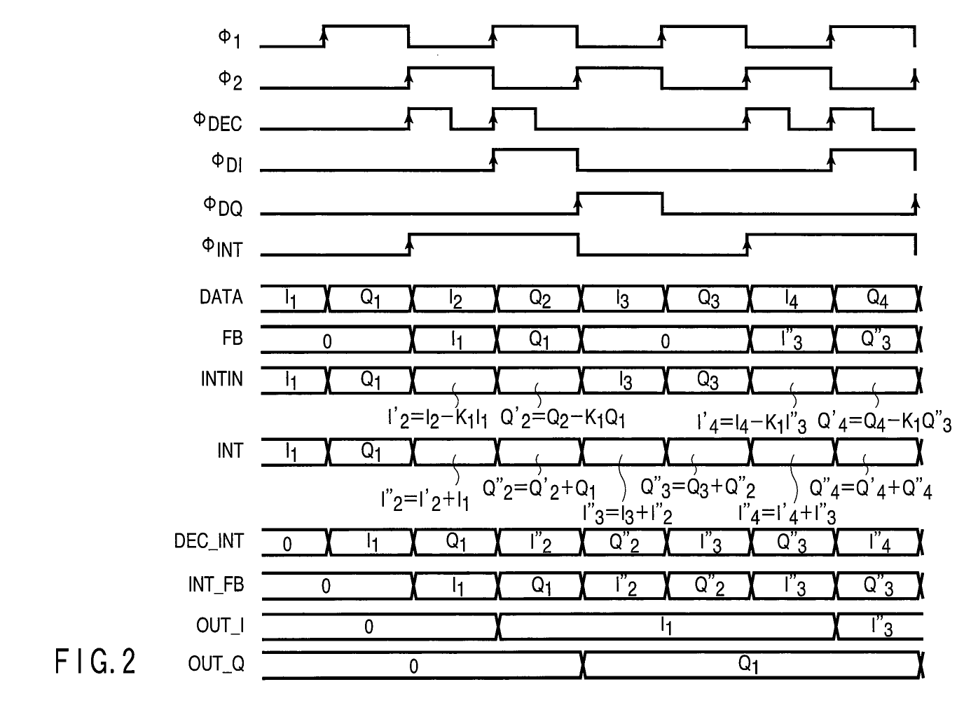

The operation of the sample rate converter in FIG. 1 is described below in detail using a timing chart shown in FIG. 2. The circuit operation of the sample rate converter in FIG. 1 is roughly composed of four phases, and a series of operations is performed at a cycle double the control clocks φ1 and φ2. Moreover, the decimation rate D of the sample rate converter in FIG. 1 is equal to 2. In addition, although the decimation rate D is equal to 2 in the example of the case in FIG. 2, any value can be obtained by properly setting values of the control clocks φDEC, φINT and the value of the coefficient K1 of the multiplier circuit.

First, in the first phase (from a start point in the timing chart to the first rising of the control clock φ1 in FIG. 2), the signals associated with the DATA_I are processed.

The control clock φ1 is “0” in the first phase, so that the input signal DATA_I (=I1) is selected by the multiplexer 101 as the selected input signal DATA and input to the subtracter 121. Moreover, the control clock φINT is “0” in the first phase, so that the value of the feedback signal FB is also “0”, and the result of the multiplication in the multiplier 122 is “0”. Thus, the subtracter 121 inputs the selected input signal DATA_I (=I1) as it is to the adder 123 as the integrator input signal INTIN.

The adder 123 adds the integrator input signal INTIN (=1) to the integrator feedback signal INT_FB from the multiplexer 141. The control clock φ1 is “0” in the first phase, so that the previous integrated signal INT (=0) associated with the DATA_I held in the flip-flop 130-1 in the register circuit 130 is selected as the integrator feedback signal INT_FB. Thus, the adder 123 inputs the result of the addition (=I1) of the integrator input signal INTIN (=I1) to the integrator feedback signal INT_FB (=0) to the register circuit 130 as the integrated signal INT. This integrated signal INT (=I1) is held by the flip-flop 130-1 at the rising of the control clock φ1.

Then, in the second phase (from the first rising of the control clock φ1 to the first rising of the control clock φ2 in FIG. 2), the signals associated with the DATA_Q are processed.

The control clock φ1 is “1” in the second phase, so that the input signal DATA_Q (=Q1) is selected by the multiplexer 101 as the selected input signal DATA and input to the subtracter 121. Moreover, the control clock φINT is “0” in the second phase, so that the value of the feedback signal FB is also “0”, and the result of the multiplication in the multiplier 122 is “0”. Thus, the subtracter 121 inputs the selected input signal DATA_I (=Q1) as it is to the adder 123 as the integrator input signal INTIN.

The adder 123 adds the integrator input signal INTIN (=Q1) to the integrator feedback signal INT_FB from the multiplexer 141. The control clock φ1 is “1” in the second phase, so that the previous integrated signal INT (=0) associated with the DATA_Q held in the flip-flop 130-2 in the register circuit 130 is selected as the integrator feedback signal INT_FB. Thus, the adder 123 inputs the result of the addition (=Q1) of the integrator input signal INTIN (=Q1) to the integrator feedback signal INT_FB (=0) to the register circuit 130 as the integrated signal INT. This integrated signal INT (=Q1) is held by the flip-flop 130-2 at the rising of the control clock φ2.

Furthermore, the control clock φ2 is “0” in the second phase, so that the multiplexer 104 selects the previous integrated signal INT (=I1) associated with the DATA_I held in the flip-flop 130-1 in the register circuit 130 as the decimator input signal DEC_INT.

Then, in the third phase (from the first rising of the control clock φ2 to the second rising of the control clock φ1 in FIG. 2), the signals associated with the DATA_I are again processed.

The control clock φ1 is “0” in the third phase, so that the input signal DATA_I (=I2) is selected by the multiplexer 101 as the selected input signal DATA and input to the subtracter 121. In the meantime, the control clock φDEC rises at the start of the third phase, and the decimator input signal DEC_INT at this point is I1 as described above. Thus, the decimator 103 holds the decimator input signal DEC_INT (=I1), and also inputs it to the interpolator 102 and the output discrimination circuit 110 as the decimator output signal. The control clock φINT is “1” in the third phase, so that the interpolator 102 inputs the decimator input signal DEC_INT (=I1) to the multiplier 122 as the feedback signal FB. The multiplier 122 multiplies the feedback signal FB (=I1) by the multiplier coefficient K1, and inputs the result of the multiplication (=K1*I1) to the subtracter 121. Thus, the subtracter 121 subtracts the multiplication result (=K1*I1) from the selected input signal DATA (=I2), and inputs the result of the subtraction (=I2−K1*I1=I′2) to the adder 123 as the integrator input signal INTIN.

The adder 123 adds the integrator input signal INTIN (=I′2) to the integrator feedback signal INT_FB from the multiplexer 141. The control clock φ1 is “0” in the third phase, so that the previous integrated signal INT (=I1) associated with the DATA_I held in the flip-flop 130-1 in the register circuit 130 is selected as the integrator feedback signal INT_FB. Thus, the adder 123 inputs the result of the addition (=I′2+I1=I″2) of the integrator input signal INTIN (=I′2) to the integrator feedback signal INT_FB (=I1) to the register circuit 130 as the integrated signal INT. This integrated signal INT (=I″2) is held by the flip-flop 130-1 at the rising of the control clock φ1.

Furthermore, the control clock φ2 is “1” in the third phase, so that the multiplexer 104 selects the previous integrated signal INT (=Q1) associated with the DATA_Q held in the flip-flop 130-2 in the register circuit 130 as the decimator input signal DEC_INT.

The control clock φDI rises at the end of the third phase, and the decimator output signal (=I1) at this point is held by the flip-flop 110-1 in the output discrimination circuit 110, and output as the output signal OUT_I.

Then, in the fourth phase (from the second rising of the control clock φ1 to the second rising of the control clock φ2 in FIG. 2), the signals associated with the DATA_Q are again processed.

The control clock φ1 is “1” in the fourth phase, so that the input signal DATA_Q (=Q2) is selected by the multiplexer 101 as the selected input signal DATA and input to the subtracter 121. In the meantime, the control clock φDEC rises at the start of the fourth phase, and the decimator input signal DEC_INT at this point is Q1 as described above. Thus, the decimator 103 holds the decimator input signal DEC_INT (=Q1), and also inputs it to the interpolator 102 and the output discrimination circuit 110 as the decimator output signal. The control clock φINT is “1” in the fourth phase, so that the interpolator 102 inputs the decimator input signal DEC_INT (=Q1) to the multiplier 122 as the feedback signal FB. The multiplier 122 multiplies the feedback signal FB (=Q1) by the multiplier coefficient K1, and inputs the result of the multiplication (=K1*Q1) to the subtracter 121. Thus, the subtracter 121 subtracts the multiplication result (=K1*Q1) from the selected input signal DATA (=Q2), and inputs the result of the subtraction (=Q2−K1*Q1=Q′2) to the adder 123 as the integrator input signal INTIN.

The adder 123 adds the integrator input signal INTIN (=Q′2) to the integrator feedback signal INT_FB from the multiplexer 141. The control clock φ1 is “1” in the fourth phase, so that the previous integrated signal INT (=Q1) associated with the DATA_Q held in the flip-flop 130-2 in the register circuit 130 is selected as the integrator feedback signal INT_FB. Thus, the adder 123 inputs the result of the addition (=Q′2+Q1=Q″2) of the integrator input signal INTIN (=Q′2) to the integrator feedback signal INT_FB (=Q1) to the register circuit 130 as the integrated signal INT. This integrated signal INT (=Q″2) is held by the flip-flop 130-2 at the rising of the control clock φ2.

Furthermore, the control clock φ2 is “0” in the fourth phase, so that the multiplexer 104 selects the previous integrated signal INT (=I″2) associated with the DATA_I held in the flip-flop 130-1 in the register circuit 130 as the decimator input signal DEC_INT.

The control clock φDQ rises at the end of the fourth phase, and the decimator output signal (=Q1) at this point is held by the flip-flop 110-2 in the output discrimination circuit 110, and output as the output signal OUT_Q.

The sample rate converter in FIG. 1 repeats the above four phases, and thereby functions as a sample rate converter having 1st-order sinc-filter characteristics and having a decimation rate of 2 for the input signals of the two I/Q channels different by 180 degrees in phase.

As shown in FIG. 2, I1 and I3″ are output as the output signals OUT_I associated with the DATA_I from the flip-flop 110-1 in the output discrimination circuit 110, and I5″, I7″ . . . are then output in the same manner. Further, Q1 is output as the output signal OUT_Q associated with the DATA_Q from the flip-flop 110-2 in the output discrimination circuit 110, and Q3″, Q5″ . . . are then output in the same manner. Folding noise has been suppressed by integration in the output signals OUT_I and the output signal OUT_Q.

As described above, in the sample rate converter according to the present embodiment, the subtracter, the multiplier and the adder included in the loop filter for suppressing the folding noise are shared, such that the sample rate of the I/Q channel signals is converted with a circuit size substantially equal to the size of one sample rate converter. That is, the sample rate converter according to the present embodiment comprises the register circuit for holding the integrated signals associated with the I/Q channel signals, and achieves the above-mentioned sharing by operating the subtracter, the multiplier, the adder, the decimator and the interpolator at a speed double the normal speed. Thus, the sample rate converter according to the present embodiment is capable of preventing an increase in the subtracter, multiplier and adder with the increase in the number of input signals, thereby making it possible to prevent an increase in the circuit area and power consumption.

### Second Embodiment

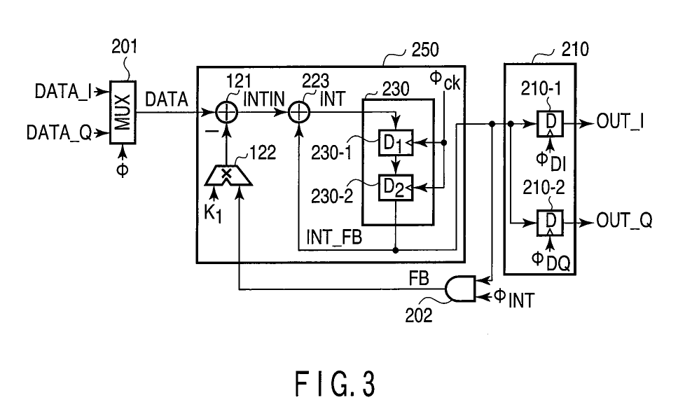

As shown in FIG. 3, a sample rate converter according to a second embodiment of the invention has a multiplexer 201, an interpolator 202, an output discrimination circuit 210 and a loop filter 250. The sample rate converter in FIG. 3 performs decimation to multiply the sample rate of input signals on I and Q channels (on two channels) 1/D times. In the following explanation, the same numerals are assigned to the same parts in FIG. 3 as those in FIG. 1, and different parts are mainly disclosed. The loop filter 250 is a 1st-order sinc-filter for suppressing folding noise, and includes a subtracter 121, a multiplier 122, an adder 223 and a register circuit 230.

The multiplexer 201 selects either an input signal DATA_I or an input signal DATA_Q, and inputs the selected input signal DATA to the subtracter 121. Specifically, the multiplexer 201 selects the input signal DATA_I as the selected input signal DATA if a control clock φ having the same sample rate as the input signals DATA_I and DATA_Q is “0”. On the other hand, the multiplexer 101 selects the input signal DATA_Q as the selected input signal DATA if the control clock φ is “1”. Here, the input signal DATA_I and the input signal DATA_Q are similar to those described in the first embodiment.

The adder 223 performs integration by adding an integrator input signal INTIN from the subtracter 121 to an integrator feedback signal INT_FB from the register circuit 230 described later. The adder 223 inputs the result of the addition to the register circuit 230 as an integrated signal INT.

The register circuit 230 is a shift register circuit in which two flip-flops 230-1 and 230-2 controlled by the common control clock φck are cascaded. In addition, the sample rate of the control clock φck is double the sample rate of the control clock φ. That is, a signal held by the register circuit 230 is taken out when one cycle corresponding to the sample rate of the control clock φ has passed.

The integrated signal INT from the adder 223 is input to the flip-flop 230-1. On the other hand, an output signal of the flip-flop 230-1 is input to the flip-flop 230-2. That is, the integrated signal INT associated with the DATA_I and the integrated signal INT associated with the DATA_Q are alternately held in the flip-flop 230-1 and the flip-flop 230-2. An output signal of the flip-flop 230-2 is input to the adder 223, the output discrimination circuit 210 and the interpolator 202 as the integrator feedback signal INT_FB.

The interpolator 202 performs interpolation in which “0” is inserted so that the sampling number of the integrator feedback signals INT_FB from the register circuit 230 may be D times. Specifically, the interpolator 202 performs an AND operation between a control clock φINT having a sample rate 1/D times as high as that of the control clock φ, and the integrator feedback signal INT_FB, and the interpolator 202 then inputs the result of the operation to the multiplier 122 as a feedback signal FB.

The output discrimination circuit 210 includes a flip-flop 210-1 for discriminating an output signal OUT_I associated with the DATA_I, and a flip-flop 210-2 for discriminating an output signal OUT_Q associated with the DATA_Q.

The integrator feedback signal INT_FB from the register circuit 230 is commonly input to the flip-flop 210-1 and the flip-flop 210-2. The output signal OUT_I and the output signal OUT_Q are time-divisionally multiplexed in the integrator feedback signal INT_FB. The flip-flop 210-1 is controlled by a control clock φDI, and the flip-flop 210-2 is controlled by a control clock φDQ.

At the rising of the control clock φDI, the integrator feedback signal INT_FB associated with the DATA_I is input to the output discrimination circuit 210, and the flip-flop 210-1 holds this integrator feedback signal INT_FB and outputs it as the output signal OUT_I. On the other hand, at the rising of the control clock φDQ, the integrator feedback signal INT_FB associated with the DATA_Q is input to the output discrimination circuit 210, and the flip-flop 210-2 holds this integrator feedback signal INT_FB and outputs it as the output signal OUT_Q.

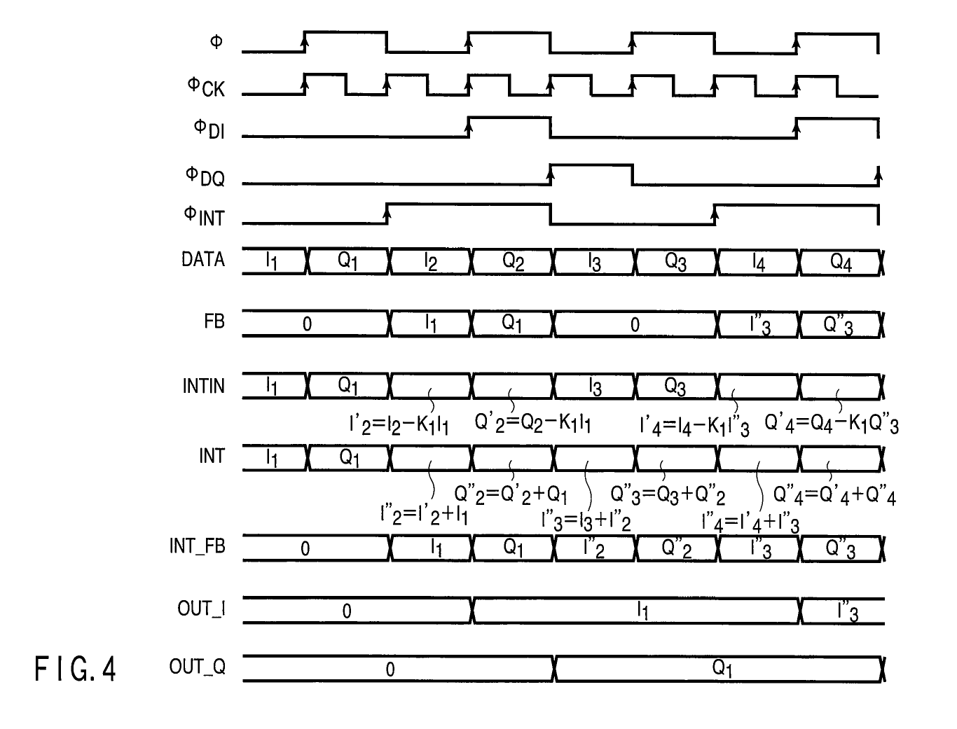

The operation of the sample rate converter in FIG. 3 is described below in detail using a timing chart shown in FIG. 4. The circuit operation of the sample rate converter in FIG. 3 is roughly composed of four phases, and a series of operations is performed at a cycle double the control clock φ. Moreover, the decimation rate D of the sample rate converter in FIG. 3 is equal to 2.

First, in the first phase (from a start point in the timing chart to the first rising of the control clock φin FIG. 4), the signals associated with the DATA_I are processed.

The control clock φis “0” in the first phase, so that the input signal DATA_I (=I1) is selected by the multiplexer 201 as the selected input signal DATA and input to the subtracter 121. Moreover, the control clock φINT is “0” in the first phase, so that the value of the feedback signal FB is also “0”, and the result of the multiplication in the multiplier 122 is “0”. Thus, the subtracter 121 inputs the selected input signal DATA_I (=I1) as it is to the adder 223 as the integrator input signal INTIN.

The adder 223 adds the integrator input signal INTIN (=I1) to the integrator feedback signal INT_FB from the register circuit 230. In the first phase, the previous integrated signal INT (=0) associated with the DATA_Q and the previous integrated signal INT (=0) associated with the DATA_I are held in the flip-flop 230-1 and the flip-flop 230-2 in the register circuit 230, respectively. Therefore, the previous integrated signal INT (=0) associated with the DATA_I is input from the flip-flop 230-2 to the adder 223, the output discrimination circuit 210 and the interpolator 202 as the integrator feedback signal INT_FB. Thus, the adder 223 inputs the result of the addition (=I1) of the integrator input signal INTIN (=I1) to the integrator feedback signal INT_FB (=0) to the register circuit 230 as the integrated signal INT.

The control clock φck rises at the end of the first phase, and the integrated signal INT (=I1) is held in the flip-flop 230-1, and the content (=0) held in the flip-flop 230-1 is shifted to the flip-flop 230-2.

Then, in the second phase (from the first rising to the first falling of the control clock φ in FIG. 4), the signals associated with the DATA_Q are processed.

The control clock φ is “1” in the second phase, so that the input signal DATA_Q (=Q1) is selected by the multiplexer 201 as the selected input signal DATA and input to the subtracter 121. Moreover, the control clock φINT is “0” in the second phase, so that the value of the feedback signal FB is also “0”, and the result of the multiplication in the multiplier 122 is “0”. Thus, the subtracter 121 inputs the selected input signal DATA (=Q1) as it is to the adder 223 as the integrator input signal INTIN.

The adder 223 adds the integrator-input signal INTIN (=Q1) to the integrator feedback signal INT_FB from the register circuit 230. In the second phase, the previous integrated signal INT (=I1) associated with the DATA_I and the previous integrated signal INT (=0) associated with the DATA_Q are held in the flip-flop 230-1 and the flip-flop 230-2 in the register circuit 230, respectively. Therefore, the previous integrated signal INT (=0) associated with the DATA_Q is input from the flip-flop 230-2 to the adder 223, the output discrimination circuit 210 and the interpolator 202 as the integrator feedback signal INT_FB. Thus, the adder 223 inputs the result of the addition (=Q1) of the integrator input signal INTIN (=Q1) to the integrator feedback signal INT_FB (=0) to the register circuit 230 as the integrated signal INT.

The control clock φck rises at the end of the second phase, and the integrated signal INT (=Q1) is held in the flip-flop 230-1, and the content (=I1) held in the flip-flop 230-1 is shifted to the flip-flop 230-2.

Then, in the third phase (from the first falling to the second rising of the control clock φ in FIG. 4), the signals associated with the DATA_I are again processed.

The control clock φis “0” in the third phase, so that the input signal DATA_I (=I2) is selected by the multiplexer 201 as the selected input signal DATA and input to the subtracter 121. In the third phase, the previous integrated signal INT (=Q1) associated with the DATA_Q and the previous integrated signal INT (=I1) associated with the DATA_I are held in the flip-flop 230-1 and the flip-flop 230-2 in the register circuit 230, respectively. Therefore, the previous integrated signal INT (=I1) associated with the DATA_I is input from the flip-flop 230-2 to the adder 223, the output discrimination circuit 210 and the interpolator 202 as the integrator feedback signal INT_FB.

The control clock φINT is “1” in the third phase, so that the interpolator 202 inputs the integrator feedback signal INT_FB (=I1) to the multiplier 122 as the feedback signal FB. The multiplier 122 multiplies the feedback signal FB (=I1) by the multiplier coefficient K1, and inputs the result of the multiplication (=K1*I1) to the subtracter 121. Thus, the subtracter 121 subtracts the multiplication result (=K1*I1) from the selected input signal DATA (=I2), and inputs the result of the subtraction (=I2−K1*I1=I′2) to the adder 223 as the integrator input signal INTIN.

The adder 223 adds the integrator input signal INTIN (=I′2) to the integrator feedback signal INT_FB (=I1). Thus, the adder 223 inputs the result of the addition (=I′2+I1=I″2) of the integrator input signal INTIN (=I′2) to the integrator feedback signal INT_FB (=I1) to the register circuit 230 as the integrated signal INT.

The control clock φck rises at the end of the third phase, and the integrated signal INT (=I″2) is held in the flip-flop 230-1, and the content (=Q1) held in the flip-flop 230-1 is shifted to the flip-flop 230-2. Moreover, the control clock φDI rises at the end of the third phase, and the integrator feedback signal INT_FB (=I1) at this point is held by the flip-flop 210-1 in the output discrimination circuit 210, and output as the output signal OUT_I.

Then, in the fourth phase (from the second rising to the second falling of the control clock φ in FIG. 4), the signals associated with the DATA_Q are again processed.

The control clock φis “1” in the fourth phase, so that the input signal DATA_Q (=Q2) is selected by the multiplexer 201 as the selected input signal DATA and input to the subtracter 121. In the fourth phase, the previous integrated signal INT (=I″2) associated with the DATA_I and the previous integrated signal INT (=Q1) associated with the DATA_Q are held in the flip-flop 230-1 and the flip-flop 230-2 in the register circuit 230, respectively. Therefore, the previous integrated signal INT (=Q1) associated with the DATA_Q is input from the flip-flop 230-2 to the adder 223, the output discrimination circuit 210 and the interpolator 202 as the integrator feedback signal INT_FB.

The control clock φINT is “1” in the fourth phase, so that the interpolator 202 inputs the integrator feedback signal INT_FB (=Q1) to the multiplier 122 as the feedback signal FB. The multiplier 122 multiplies the feedback signal FB (=Q1) by the multiplier coefficient K1, and inputs the result of the multiplication (=K1*Q1) to the subtracter 121. Thus, the subtracter 121 subtracts the multiplication result (=K1*Q1) from the selected input signal DATA (=Q2), and inputs the result of the subtraction (=Q2−K1*Q1=Q′2) to the adder 223 as the integrator input signal INTIN.

The adder 223 adds the integrator input signal INTIN (=Q′2) to the integrator feedback signal INT_FB (=Q1). Thus, the adder 223 inputs the result of the addition (=Q′2+Q1=Q″2) of the integrator input signal INTIN (=Q′2) to the integrator feedback signal INT_FB (=Q1) to the register circuit 230 as the integrated signal INT.

The control clock φck rises at the end of the fourth phase, and the integrated signal INT (=Q″2) is held in the flip-flop 230-1, and the content (_I″2) held in the flip-flop 230-1 is shifted to the flip-flop 230-2. Moreover, the control clock φDQ rises at the end of the fourth phase, and the integrator feedback signal INT_FB (=Q1) at this point is held by the flip-flop 210-2 in the output discrimination circuit 210, and output as the output signal OUT_Q.

The sample rate converter in FIG. 3 repeats the above four phases, and thereby functions as a sample rate converter having 1st-order sinc-filter characteristics and having a decimation rate of 2 for the input signals of the two I/Q channels different by 180 degrees in phase.

As shown in FIG. 4, I1 and I3″ are output as the output signals OUT_I associated with the DATA_I from the flip-flop 210-1 in the output discrimination circuit 210, and I5″, I7″ . . . are then output in the same manner. Further, Q1 is output as the output signal OUT_Q associated with the DATA_Q from the flip-flop 210-2 in the output discrimination circuit 210, and Q3″, Q5″ . . . are then output in the same manner. Folding noise has been suppressed by integration in the output signals OUT_I and the output signal OUT_Q.

In the sample rate converter according to the first embodiment previously described, the multiplexer 104 and the decimator 103 are used to provide the integrated signal INT one cycle before to the interpolator 102. However, in the sample rate converter according to the present embodiment, the integrator feedback signal INT_FB from the register circuit 230 is the above-mentioned integrated signal INT one cycle before, so that the integrator feedback signal INT_FB can be directly input to the interpolator 202. Therefore, the sample rate converter according to the present embodiment doesn't need the above-mentioned multiplexer 104 and decimator 103, and can thus have simpler circuits than in the first embodiment.

### Third Embodiment

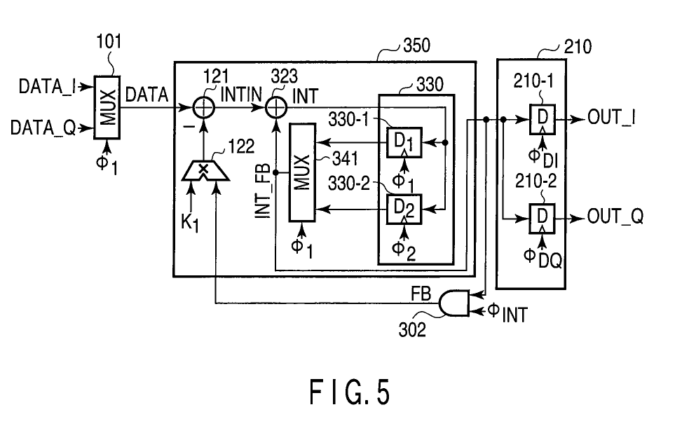

As shown in FIG. 5, a sample rate converter according to a third embodiment of the invention has a multiplexer 101, an interpolator 302, an output discrimination circuit 210 and a loop filter 350. The sample rate converter in FIG. 5 performs decimation to multiply the sample rate of input signals on I and Q channels (on two channels) 1/D times. In the following explanation, the same numerals are assigned to the same parts in FIG. 5 as those in FIG. 1 or 3, and different parts are mainly disclosed. The loop filter 350 is a 1st-order sinc-filter for suppressing folding noise, and includes a subtracter 121, a multiplier 122, an adder 323, a register circuit 330 and a multiplexer 341.

The multiplexer 101 selects either an input signal DATA_I or an input signal DATA_Q, and inputs the selected input signal DATA to the subtracter 121. Specifically, the multiplexer 101 selects the input signal DATA_I as the selected input signal DATA if a control clock φ1 is “0”. On the other hand, the multiplexer 101 selects the input signal DATA_Q as the selected input signal DATA if the control clock φ1 is “1”. Here, the input signal DATA_I and the input signal DATA_Q are similar to those previously described in the first embodiment.

The multiplier 122 multiplies a feedback signal FB from the interpolator 302, described later, by a predetermined multiplier coefficient K1, and inputs the result of the multiplication to the subtracter 121. In addition, the multiplier coefficient K1 is determined by a decimation rate D of the sample rate converter in FIG. 5.

The subtracter 121 subtracts the multiplication result from the multiplier 122, from the selected input signal DATA from the multiplexer 101. That is, the subtracter 121 subtracts the feedback signal FB multiplied K1 in the multiplier 122 from the selected input signal DATA. The subtracter 121 inputs the result of the subtraction to the adder 323 as an integrator input signal INTIN.

The adder 323 performs integration by adding the integrator input signal INTIN from the subtracter 121 to an integrator feedback signal INT_FB from the multiplexer 341 described later. The adder 323 inputs the result of the addition to the register circuit 330 as an integrated signal INT.

The register circuit 330 includes a flip-flop 330-1 for temporarily holding the integrated signal INT associated with the DATA_I, and a flip-flop 330-2 for temporarily holding the integrated signal INT associated with the DATA_Q. Specifically, the flip-flop 330-1 makes the transition into a latched state in accordance with the rising edge of the control clock φ1 to hold the input signal and output this signal until the next rising edge. On the other hand, the flip-flop 330-2 is controlled by a control clock φ2.

The integrated signal INT from the adder 323 is commonly input to the flip-flop 330-1 and the flip-flop 330-2. At the rising of the control clock φ1, the integrated signal INT associated with the DATA_I is input to the register circuit 330, and the flip-flop 330-1 holds this integrated signal INT. Then, the flip-flop 330-1 inputs this integrated signal INT to the multiplexer 341 until the next rising edge of the control clock φ1. On the other hand, at the rising of the control clock φ2, the integrated signal INT associated with the DATA_Q is input to the register circuit 330, and the register circuit 330-2 holds this integrated signal INT. Then, the flip-flop 330-2 inputs this integrated signal INT to the multiplexer 341 until the next rising edge of the control clock φ2.

The multiplexer 341 selects one of the signals from the flip-flop 330-1 and the flip-flop 330-2 in the register circuit 330, and inputs the selected signal to the adder 323, the output discrimination circuit 210 and the interpolator 302 as the integrator feedback signal INT_FB. Specifically, the multiplexer 341 selects the signal from the flip-flop 330-1 as the integrator feedback signal INT_FB if the control clock φ1 is “0”. On the other hand, the multiplexer 341 selects the signal from the flip-flop 330-2 as the integrator feedback signal INT_FB if the control clock φ1 is “1”.

The interpolator 302 performs interpolation in which “0” is inserted so that the sampling number of the integrator feedback signals INT_FB from the multiplexer 341 may be D times. Specifically, the interpolator 302 performs an AND operation between a control clock φINT having a sampling rate 1/D times as high as that of the control clock φ1 and the control clock φ2, and the integrator feedback signal INT_FB, and the interpolator 302 then inputs the result of the operation to the multiplier 122 as the feedback signal FB.

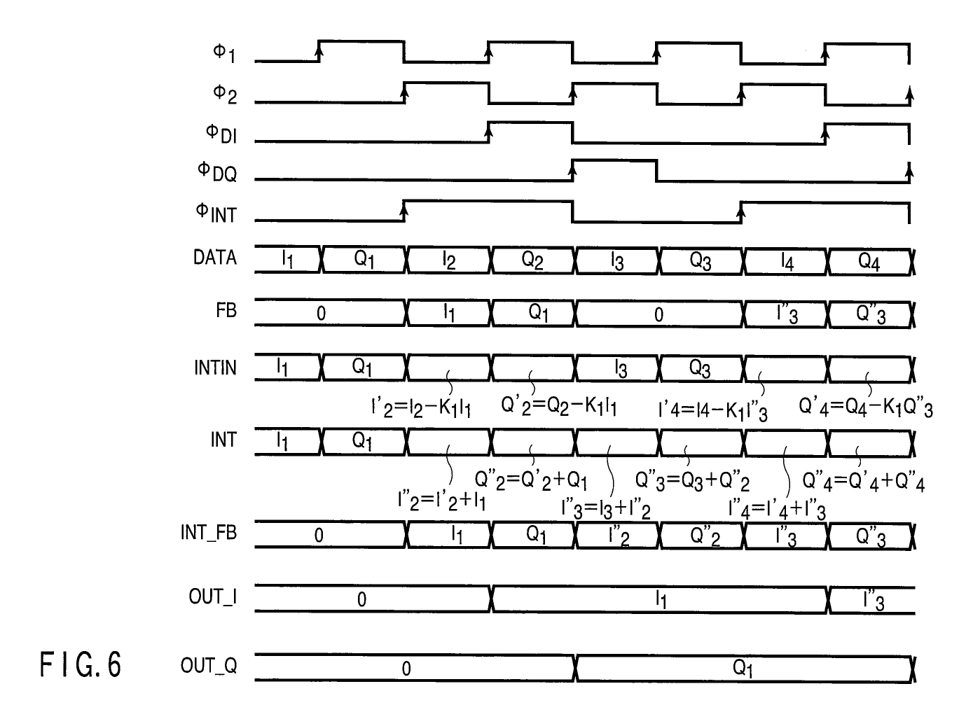

The operation of the sample rate converter in FIG. 5 is described below in detail using a timing chart shown in FIG. 6. The circuit operation of the sample rate converter in FIG. 5 is roughly composed of four phases, and a series of operations is performed at a cycle double the control clocks φ1 and φ2. Moreover, the decimation rate D of the sample rate converter in FIG. 5 is equal to 2.

First, in the first phase (from a start point in the timing chart to the first rising of the control clock φ1 in FIG. 6), the signals associated with the DATA_I are processed.

The control clock φ is “0” in the first phase, so that the input signal DATA_I (=I1) is selected by the multiplexer 101 as the selected input signal DATA and input to the subtracter 121. Moreover, the control clock φINT is “0” in the first phase, so that the value of the feedback signal FB is also “0”, and the result of the multiplication in the multiplier 122 is “0”. Thus, the subtracter 121 inputs the selected input signal DATA_I (=I1) as it is to the adder 323 as the integrator input signal INTIN.

The adder 323 adds the integrator input signal INTIN (=I1) to the integrator feedback signal INT_FB from the multiplexer 341. The control clock φ1 is “0” in the first phase, so that the previous integrated signal INT (=0) associated with the DATA_I held in the flip-flop 330-1 in the register circuit 330 is selected as the integrator feedback signal INT_FB. Thus, the adder 323 inputs the result of the addition (=I1) of the integrator input signal INTIN (=I1) to the integrator feedback signal INT_FB (=0) to the register circuit 330 as the integrated signal INT. This integrated signal INT (=I1) is held by the flip-flop 330-1 at the rising of the control clock φ1.

Then, in the second phase (from the first rising of the control clock φ1 to the first rising of the control clock φ2 in FIG. 6), the signals associated with the DATA_Q are processed.

The control clock φ1 is “1” in the second phase, so that the input signal DATA_Q (=Q1) is selected by the multiplexer 101 as the selected input signal DATA and input to the subtracter 121. Moreover, the control clock φINT is “0” in the second phase, so that the value of the feedback signal FB is also “0”, and the result of the multiplication in the multiplier 122 is “0”. Thus, the subtracter 121 inputs the selected input signal DATA (=Q1) as it is to the adder 323 as the integrator input signal INTIN.

The adder 323 adds the integrator input signal INTIN (=Q1) to the integrator feedback signal INT_FB from the multiplexer 341. The control clock φ1 is “1” in the second phase, so that the previous integrated signal INT (=0) associated with the DATA_Q held in the flip-flop 330-2 in the register circuit 330 is selected as the integrator feedback signal INT_FB. Thus, the adder 323 inputs the result of the addition (=Q1) of the integrator input signal INTIN (=Q1) to the integrator feedback signal INT_FB (=0) to the register circuit 330 as the integrated signal INT. This integrated signal INT (=Q1) is held by the flip-flop 330-1 at the rising of the control clock φ2.

Then, in the third phase (from the first rising of the control clock φ2 to the second rising of the control clock φ1 in FIG. 6), the signals associated with the DATA_I are again processed.

The control clock φ1 is “0” in the third phase, so that the input signal DATA_I (=I2) is selected by the multiplexer 101 as the selected input signal DATA and input to the subtracter 121. The multiplexer 341 selects the previous integrated signal INT (=I1) associated with the DATA_I held in the flip-flop 330-1 in the register circuit 330 as the integrator feedback signal INT_FB. Moreover, the control clock φINT is “1” in the third phase, so that the interpolator 302 inputs the integrator feedback signal INT_FB (=I1) to the multiplier 122 as the feedback signal FB. The multiplier 122 multiplies the feedback signal FB (=I1) by the multiplier coefficient K1, and inputs the result of the multiplication (=K1*I1) to the subtracter 121. Thus, the subtracter 121 subtracts the multiplication result (=K1*I1) from the selected input signal DATA (=I2), and inputs the result of the subtraction (=I2−K1*I1=I′2) to the adder 323 as the integrator input signal INTIN.

The adder 323 adds the integrator input signal INTIN (=I′2) to the integrator feedback signal INT_FB. Thus, the adder 323 inputs the result of the addition (=I′2+I1=I″2) of the integrator input signal INTIN (=I′2) to the integrator feedback signal INT_FB (=I1) to the register circuit 330 as the integrated signal INT. This integrated signal INT (=I″2) is held by the flip-flop 330-1 at the rising of the control clock φ1.

The control clock φDI rises at the end of the third phase, and the integrator feedback signal INT_FB (=I1) at this point is held by the flip-flop 210-1 in the output discrimination circuit 210, and output as the output signal OUT_I.

Then, in the fourth phase (from the second rising of the control clock φ1 to the second rising of the control clock φ2 in FIG. 6), the signals associated with the DATA_Q are again processed.

The control clock φ1 is “1” in the fourth phase, so that the input signal DATA_Q (=Q2) is selected by the multiplexer 101 as the selected input signal DATA and input to the subtracter 121. The multiplexer 341 selects the previous integrated signal INT (=Q1) associated with the DATA_Q held in the flip-flop 330-2 in the register circuit 330 as the integrator feedback signal INT_FB. The control clock φINT is “1” in the fourth phase, so that the interpolator 302 inputs the integrator feedback signal INT_FB (=Q1) to the multiplier 122 as the feedback signal FB. The multiplier 122 multiplies the feedback signal FB (=Q1) by the multiplier coefficient K1, and inputs the result of the multiplication (=K1*Q1) to the subtracter 121. Thus, the subtracter 121 subtracts the multiplication result (=K1*Q1) from the selected input signal DATA (=Q2), and inputs the result of the subtraction (=Q2−K1*Q1=Q′2) to the adder 323 as the integrator input signal INTIN.

The adder 323 adds the integrator input signal INTIN (=Q′2) to the integrator feedback signal INT_FB from the multiplexer 341. The control clock φ1 is “1” in the fourth phase, so that the previous integrated signal INT (=Q1) associated with the DATA_Q held in the flip-flop 330-2 in the register circuit 330 is selected as the integrator feedback signal INT_FB. Thus, the adder 323 inputs the result of the addition (=Q′2+Q1=Q″2) of the integrator input signal INTIN (=Q′2) to the integrator feedback signal INT_FB (=Q1) to the register circuit 330 as the integrated signal INT. This integrated signal INT (=Q″2) is held by the flip-flop 330-2 at the rising of the control clock φ2.

The control clock φDQ rises at the end of the fourth phase, and the integrator feedback signal INT_FB (=Q1) at this point is held by a flip-flop 210-2 in the output discrimination circuit 210, and output as an output signal OUT_Q.

The sample rate converter according to the present embodiment repeats the above four phases, and thereby functions as a sample rate converter having 1st-order sinc-filter characteristics and having a decimation rate of 2 for the input signals of the two I/Q channels different by 180 degrees in phase.

As shown in FIG. 6, I2 and I3″ are output as the output signals OUT_I associated with the DATA_I from the flip-flop 210-1 in the output discrimination circuit 210, and I5″, I7″ . . . are then output in the same manner. Further, Q1 is output as the output signal OUT_Q associated with the DATA_Q from the flip-flop 210-2 in the output discrimination circuit 210, and Q3″, Q5″ . . . are then output in the same manner. Folding noise has been suppressed by integration in the output signals OUT_I and the output signal OUT_Q.

In the sample rate converter according to the first embodiment previously described, the multiplexer 104 and the decimator 103 are used to provide the integrated signal INT one cycle before to the interpolator 102. However, in the sample rate converter according to the present embodiment, the integrator feedback signal INT_FB from the multiplexer 341 is the above-mentioned integrated signal INT one cycle before, so that the integrator feedback signal INT_FB can be directly input to the interpolator 302. Therefore, the sample rate converter according to the present embodiment doesn't need the above-mentioned multiplexer 104 and decimator 103, and can thus have simpler circuits than in the first embodiment.

### Fourth Embodiment

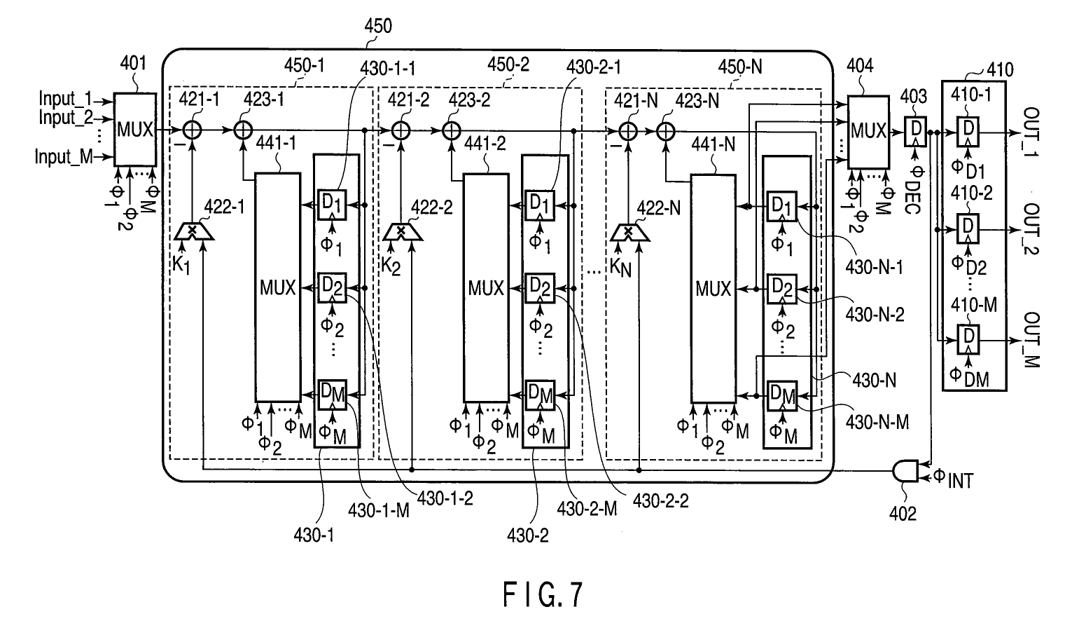

As shown in FIG. 7, a sample rate converter according to a fourth embodiment of the invention has a multiplexer 401, an interpolator 402, a decimator 403, a multiplexer 404, an output discrimination circuit 410 and a loop filter 450. The sample rate converter in FIG. 7 performs decimation to multiply the sample rate of input signals on M (M is a natural number equal to or higher than 2) channels 1/D times.

The loop filter 450 is an N-th-order sinc filter in which N (N is a natural number) stages of 1st-order sinc-filters for suppressing folding noise are cascaded, and the loop filter 450 includes loop filters 450-1 to 450-N. The i-th stage (i is a natural number equal to or higher than 1 and equal to or lower than N) loop filter 450-i includes a subtracter 421-i, a multiplier 422-i, an adder 423-i, a register circuit 430-i and a multiplexer 441-i. In addition, in general, a higher order N of the loop filter 450 enables more effective suppression of the folding noise. Moreover, more bits are required for the loop filters 450-i to represent various signals as the stage proceeds, so that, actually, the subtracters 421-i, the multipliers 422-i and the adders 423-i gradually increase in area.

The multiplexer 401 selects one of M input signals Input_1 to Input_M, and inputs the selected input signal (multiplexed input signal) to the subtracter 421-1 in the first-stage loop filter 450-1. Specifically, the multiplexer 401 selects the M input signals Input_1 to Input_M in one-to-one correspondence with M control clocks φl to φM. Here, the M control clocks φ1 to φM are M clocks obtained by shifting, by 2π/M, the phases of clocks which are, for example, “1” in a cycle equal to or less than 1/M times one cycle of the input signals Input_1 to Input_M and which have the same sample rate.

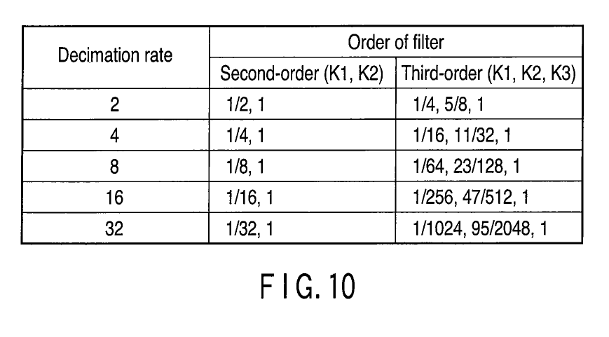

The multiplier 422-1 in the first-stage loop filter 450-1 multiplies a feedback signal from the interpolator 402, described later, by a predetermined multiplier coefficient K1, and inputs the result of the multiplication (multiplication signal) to the subtracter 421-1. In addition, the multiplier coefficient K1 and other multiplier coefficients K2 to KN are determined by a decimation rate D of the sample rate converter in FIG. 7 and the order N of the loop filter 450. Examples of N multiplier coefficients K1 to KN are shown in FIG. 10.

The subtracter 421-1 subtracts the multiplication result from the multiplier 422-1, from the selected input signal from the multiplexer 401. That is, the subtracter 421-1 subtracts the feedback signal multiplied K1 in the multiplier 422-1 from the selected input signal. The subtracter 421-1 inputs the result of the subtraction (residual signal) to the adder 423-1 as an integrator input signal.

The adder 423-1 in the first-stage loop filter 450-1 performs integration by adding the integrator input signal from the subtracter 421-1 to an integrator feedback signal from the multiplexer 441-1 described later. The adder 423-1 inputs the result of the addition to the register circuit 430-1 and to the subtracter 421-2 in the second-stage (subsequent stage) loop filter 450-2 as an integrated signal.

The register circuit 430-1 in the first-stage loop filter 450-1 includes a flip-flop 430-1-1 for temporarily holding the integrated signal associated with the input signal Input_1, a flip-flop 430-1-2 for temporarily holding the integrated signal associated with the input signal Input_2, . . . , and a flip-flop 430-1-M for temporarily holding the integrated signal associated with the input signal Input_M. Specifically, the M flip-flops 430-1-1 to 430-1-M are controlled one to one by the M control clocks φ1 to φM.

The integrated signal from the adder 423-1 is commonly input to the M flip-flops 410-1-1 to 410-1-M. At the rising of the control clock φ1, the integrated signal associated with the Input_1 is input to the register circuit 430-1, and the flip-flop 430-1-1 holds this integrated signal. Then, the flip-flop 430-1-1 inputs this integrated signal to the multiplexer 441-1 until the next rising edge of the control clock φ1. At the rising of the other control clocks φ2 to φM, the integrated signals associated with the input signals Input_2 to Input M are held by the flip-flops 430-1-2 to 430-1-M, respectively. Then, the flip-flops 430-1-2 to 430-1-M input these integrated signals to the multiplexer 441-1 until the next rising edges of the control clocks φ2 to φM.

The multiplexer 441-1 in the first-stage loop filter 450-1 selects one of the signals from the M flip-flops 430-1-1 to 430-1-M in the register circuit 430-1, and inputs the selected signal to the adder 423-1 as the integrator feedback signal. Specifically, the multiplexer 441-1 selects the signals from the M flip-flops 430-1-1 to 430-1-M in one-to-one correspondence with the M control clocks φ1 to φM.

The j-th stage (j is a natural number equal to or higher than 2 and lower than N) subtracter 421-j subtracts the multiplication result from the multiplier 422-j, from the integrated signal from the (j−1)-th stage (previous stage) adder 423-(j−1). That is, the subtracter 421-j subtracts the feedback signal multiplied Kj in the multiplier 422-j from the integrated signal. The subtracter 421-j inputs the result of the subtraction to the adder 423-j as an integrator input signal.

In addition, the multiplier 422-j, the adder 423-j, the register circuit 430-j and the multiplexer 441-j in the j-th stage loop filter 450-j are similar to the multiplier 422-1, the adder 423-1, the register circuit 430-1 and the multiplexer 441-1 that have been described above.

The subtracter 421-N in the N-th stage loop filter 450-N subtracts the multiplication result from the multiplier 422-N, from the integrated signal from the (N−1)-th stage (previous stage) adder 423-(N−1). That is, the subtracter 421-N subtracts the feedback signal multiplied KN in the multiplier 422-N from the integrated signal. The subtracter 421-N inputs the result of the subtraction to the adder 423-N as an integrator input signal.

The adder 423-N in the N-th stage loop filter 450-N performs integration by adding the integrator input signal from the subtracter 421-N to an integrator feedback signal from the multiplexer 441-N. The adder 423-N inputs the result of the addition to the register circuit 430-N as an integrated signal.

The register circuit 430-N in the N-th stage loop filter 450-N includes a flip-flop 430-N−1 for temporarily holding the integrated signal associated with the input signal Input_1, a flip-flop 430-N−2 for temporarily holding the integrated signal associated with the input signal Input_2, . . . , and a flip-flop 430-N-M for temporarily holding the integrated signal associated with the input signal Input_M. Specifically, the M flip-flops 430-N−1 to 430-N-M are controlled one to one by the M control clocks φ1 to φM.

The integrated signal from the adder 423-N is commonly input to the M flip-flops 410-N−1 to 410-N-M. At the rising of the control clock φ1, the integrated signal associated with the Input_1 is input to the register circuit 430-N, and the flip-flop 430-N−1 holds this integrated signal. Then, the flip-flop 430-N−1 inputs this integrated signal to the multiplexer 441-N and the multiplexer 404 until the next rising edge of the control clock φ1. At the rising of the other control clocks φ2 to φM, the integrated signals associated with the input signals Input_2 to Input_M are held by the flip-flops 430-N−2 to 430-N-M, respectively. Then, the flip-flops 430-N−2 to 430-N-M input these integrated signals to the multiplexer 441-N and the multiplexer 404 until the next rising edges of the control clocks φ2 to φM.

In addition, the multiplier 422-1 in the N-th stage loop filter 450-N is similar to the multipliers 422-1 and 422-i described above. Moreover, the multiplexer 441-N in the N-th stage loop filter 450-N is similar to the multiplexer 441-1 and 441-i described above.

The multiplexer 404 selects one of the signals from the M flip-flops 430-1 to 430-N in the register circuit 430-N, and inputs the selected signal to the decimator 403 as a decimator input signal. Specifically, the multiplexer 404 selects the signals from the M flip-flops 430-1-1 to 430-1-M in one-to-one correspondence with the M control clocks φ1 to φM. For example, the multiplexer 404 selects the signals from the flip-flops 430-1-1 to 430-1-(M−1) while the control clocks φ1 to φM are “1”, and selects the signal from the flip-flop 430-M while the control clock φ1 is “1”.

The decimator 403 is a flip-flop controlled by a control clock φDEC, and operates as a decimator with the decimation rate D. That is, the decimator 403 performs thinning decimation so that the sampling number of the decimator input signals (decimation target signal) from the multiplexer 404 may be 1/D times. The decimator 403 inputs the result of the decimation to the output discrimination circuit 410 and the interpolator 402 as a decimator output signal.

The interpolator 402 performs interpolation in which “0” is inserted so that the sampling number of the decimator output signals (multiplexed output signal) from the decimator 403 may be D times. Specifically, the interpolator 402 performs an AND operation between a control clock φNT having a sample rate 1/D times as high as that of the control clocks φ1 to φM, and the decimator output signal, and the interpolator 402 then inputs the result of the operation to the multipliers 422-1 to 422-N as the feedback signal.

The output discrimination circuit 410 includes flip-flops 410-1 to 410-M for discriminating output signals OUT_1 to OUT_M associated with the input signals Input_1 to Input_M. The M flip-flops 410-1 to 410-M correspond one to one to the M output signals OUT_1 to OUT_M.

The decimator output signal from the decimator 403 is commonly input to the flip-flops 410-1 to 410-M. The output signals OUT_1 to OUT_M are time-divisionally multiplexed in the decimator output signal. Moreover, the M flip-flops 410-1 to 410-M are controlled by M control clocks φD1 to φDM. That is, at the rising of the control clock φD1, the decimator output signal associated with the Input_1 is input to the output discrimination circuit 410, and the flip-flop 410-1 holds this decimator output signal and outputs it as the output signal OUT_1. Subsequently, at the rising of the control clocks φD2 to φDM, the decimator output signals associated with the input signals Input_2 to Input_M are input to the output discrimination circuit 410, and the flip-flops 410-2 to 410-M hold these decimator output signals and output them as the output signals OUT_2 to OUT_M.

In the sample rate converter according to the present embodiment, the number of input signals and the order of the loop filter in the sample rate converter according to the first embodiment previously described are extended and generalized. Any value can be obtained for the order of the loop filter by the number of loop filters to be cascaded in FIG. 7. Moreover, any value can be obtained for the number of input signals in the sample rate converter by the number of flip-flops included in the register circuit and the output discrimination circuit in FIG. 7 and by the operation speeds of the subtracters, the multipliers, the adders, the decimators and the interpolator. Therefore, in the sample rate converter according to the present embodiment, the number of input signals can be any number, and an increase in the circuit area and power consumption due to the increase in the number of input signals can be inhibited.

Furthermore, the circuit areas of the subtracter, the multiplier and the adder included in each of the stages of the loop filter increase as the stage proceeds. On the other hand, in the sample rate converter according to the present embodiment, the subtracter, the multiplier and the adder can be shared by the respective stages of the loop filter regardless of the number of input signals, so that an increase in the circuit area and power consumption can be effectively inhibited particularly when a high-order loop filter is used.

### Fifth Embodiment

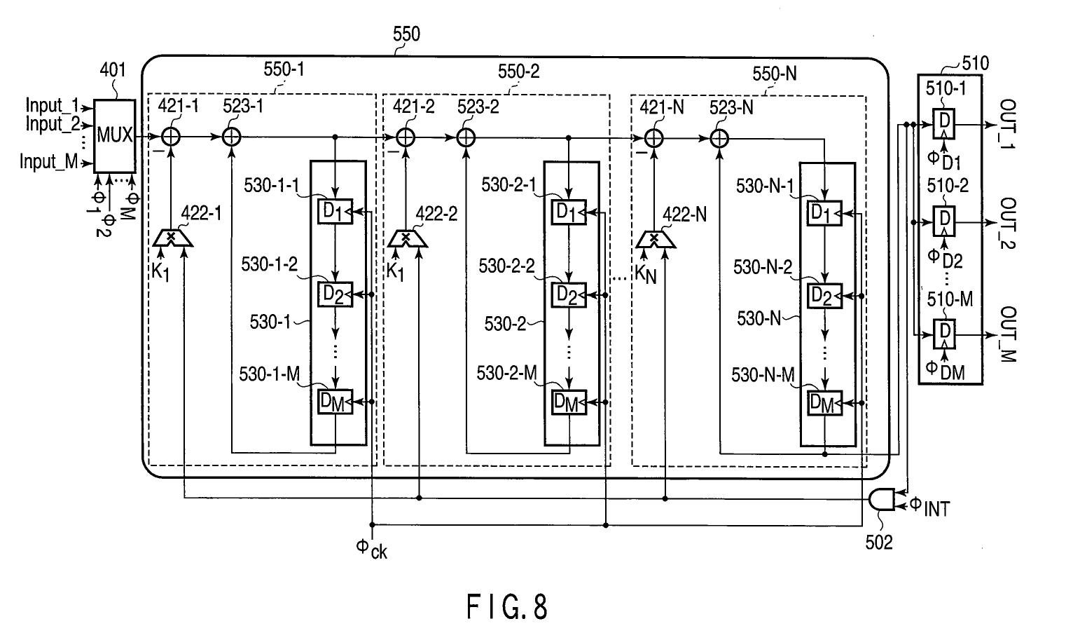

As shown in FIG. 8, a sample rate converter according to a fifth embodiment of the invention has a multiplexer 401, an interpolator 502, an output discrimination circuit 510 and a loop filter 550. The sample rate converter in FIG. 8 performs decimation to multiply the sample rate of input signals on M (M is a natural number equal to or higher than 2) channels. In the following explanation, the same numerals are assigned to the same parts in FIG. 8 as those in FIG. 7, and different parts are mainly disclosed.

The loop filter 550 is an N-th-order sinc filter in which N (N is a natural number) stages of 1st-order sinc-filters for suppressing folding noise are cascaded, and the loop filter 550 includes loop filters 550-1 to 550-N. The i-th stage (i is a natural number equal to or higher than 1 and equal to or lower than N) loop filter 550-i includes a subtracter 421-i, a multiplier 422-i, an adder 523-i and a register circuit 530-i. In addition, in general, a higher order N of the loop filter 550 enables more effective suppression of the folding noise. Moreover, more bits are required for the loop filters 550-i to represent various signals as the stage proceeds, so that, actually, the subtracters 421-i, the multipliers 422-i and the adders 523-i gradually increase in area.

The adder 523-1 in the first-stage loop filter 550-1 performs integration by adding the integrator input signal from the subtracter 421-1 to an integrator feedback signal from the register circuit 530-1 described later. The adder 523-1 inputs the result of the addition to the register circuit 530-1 and to the subtracter 421-2 in the second-stage (subsequent stage) loop filter 550-2 as an integrated signal.

The register circuit 530-1 in the first-stage loop filter 550-1 is a shift register in which M flip-flops 530-1-1 to 530-1-M controlled by the common control clock φck are cascaded. In addition, the sample rate of the control clock φck is M times the sample rate of the control clock φ. That is, a signal held by the register circuit 530-1 is taken out when one cycle corresponding to the sample rate of control clocks φ1 to φM has passed.

The integrated signal from the adder 523-1 is input to the flip-flop 530-1-1. On the other hand, an output signal of the flip-flop 530-1-1 is input to the flip-flop 530-1-2. In the same manner, the flip-flops 530-1-2 to 530-1-(M−1) are connected to the flip-flops 530-1-3 to 530-1-M at the following stages. Then, the integrator feedback signal is taken out of the flip-flop 530-1-M at the final stage, and input to the adder 523-1.

One of the integrated signals associated with the Input_1 to Input_M is input to each of the flip-flops 530-1-1 to 530-1-M with no overlap. Then, the contents held in the flip-flops 530-1-1 to 530-1-(M−1) are shifted to the following stages by the control clock φck. Thus, at every rise of the control clock φck, the integrated signals associated with the Input_1 to Input_M can be sequentially taken out of the flip-flop 530-1-M.

In addition, the adder 523-j and the register circuit 530-j in the j-th (j is a natural number equal to or higher than 2 and lower than N) stage loop filter 550-j are similar to the adder 523-1 and the register circuit 530-1 that have been described above.

The adder 523-N in the N-th stage loop filter 550-N performs integration by adding the integrator input signal from the subtracter 421-N to an integrator feedback signal from the register circuit 530-N. The adder 523-N inputs the result of the addition to the register circuit 530-N as an integrated signal.

The register circuit 530-N in the N-th stage loop filter 550-N is a shift register in which M flip-flops 530-N'11 to 530-N-M controlled by the common control clock φck are cascaded.

The integrated signal from the adder 523-N is input to the flip-flop 530-N−1. On the other hand, an output signal of the flip-flop 530-N−1 is input to the flip-flop 530-N−2. In the same manner, the flip-flops 530-N−2 to 530-N-(M−1) are connected to the flip-flops 530-N−3 to 530-N-M at the following stages. Then, the integrator feedback signal is taken out of the flip-flop 530-N-M at the final stage, and input to the adder 523-N, the output discrimination circuit 510 and the interpolator 502.

The interpolator 502 performs interpolation in which “0” is inserted so that the sampling number of the integrator feedback signals from the register circuit 530-N may be D times. Specifically, the interpolator 502 performs an AND operation between a control clock φINT having a sampling rate 1/D times as high as that of the control clocks φ1 to φM, and the integrator feedback signal, and the interpolator 502 then inputs the result of the operation to the multipliers 422-1 to 422-N as the feedback signal.

The output discrimination circuit 510 includes flip-flops 510-1 to 510-M for discriminating output signals OUT_1 to OUT_M associated with the input signals Input_1 to Input_M. The M flip-flops 510-1 to 510-M correspond one to one to the M output signals OUT_1 to OUT_M.

The integrator feedback signal from the register circuit 530-N is commonly input to the flip-flops 510-1 to 510-M. The output signals OUT_1 to OUT_M are time-divisionally multiplexed in the integrator feedback signal. Moreover, the M flip-flops 510-1 to 510-M are controlled one to one by M control clocks φD1 to φDM. That is, at the rising of the control clock φD1, the integrator feedback signal associated with the input signal Input_1 is input to the output discrimination circuit 510, and the flip-flop 510-1 holds this integrator feedback signal and outputs it as the output signal OUT_1. Subsequently, at the rising of the control clocks φD2 to φDM, the integrator feedback signals associated with the input signals Input_2 to Input_M are input to the output discrimination circuit 510, and the flip-flops 510-2 to 510-M hold these integrator feedback signals and output them as the output signals OUT_2 to OUT_M.

In the sample rate converter according to the present embodiment, the number of input signals and the order of the loop filter in the sample rate converter according to the second embodiment previously described are extended and generalized. Any value can be obtained for the order of the loop filter by the number of loop filters to be cascaded in FIG. 8. Moreover, any value can be obtained for the number of input signals in the sample rate converter by the number of flip-flops included in the register circuit and the output discrimination circuit in FIG. 8 and by the operation speeds of the subtracters, the multipliers, the adders and the interpolator. Therefore, in the sample rate converter according to the present embodiment, the number of input signals can be any number, and an increase in the circuit area and power consumption due to the increase in the number of input signals can be inhibited.

Furthermore, the circuit areas of the subtracter, the multiplier and the adder included in each of the stages of the loop filter increase as the stage proceeds. On the other hand, in the sample rate converter according to the present embodiment, the subtracter, the multiplier and the adder can be shared by the respective stages of the loop filter regardless of the number of input signals, so that an increase in the circuit area and power consumption can be effectively inhibited particularly when a high-order loop filter is used.

Still further, in the sample rate converter according to the fourth embodiment previously described, the multiplexer 404 and the decimator 403 are used to provide the integrated signal one cycle before to the interpolator 402. However, in the sample rate converter according to the present embodiment, the integrator feedback signal from the register circuit 530-N is the above-mentioned integrated signal one cycle before, so that this integrator feedback signal can be directly input to the interpolator 502. Therefore, the sample rate converter according to the present embodiment dispenses with the above-mentioned multiplexer 404 and decimator 403, and can thus have simpler circuits than in the fourth embodiment.

### Sixth Embodiment

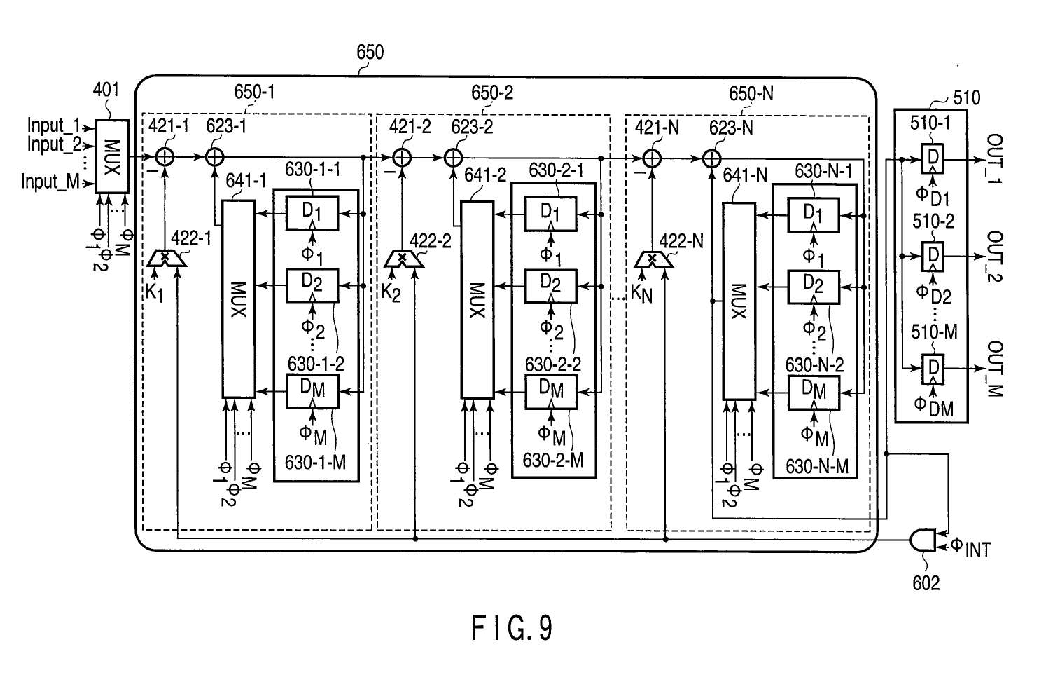

As shown in FIG. 9, a sample rate converter according to a sixth embodiment of the invention has a multiplexer 401, an interpolator 602, an output discrimination circuit 510 and a loop filter 650. The sample rate converter in FIG. 9 performs decimation to multiply the sample rate of input signals on M (M is a natural number equal to or higher than 2) channels 1/D times. In the following explanation, the same numerals are assigned to the same parts in FIG. 9 as those in FIGS. 7 and 8, and different parts are mainly disclosed.

The loop filter 650 is an N-th-order sinc filter in which N (N is a natural number) stages of 1st-order sinc-filters for suppressing folding noise are cascaded, and the loop filter 650 includes loop filters 650-1 to 650-N. The i-th stage (i is a natural number equal to or higher than 1 and equal to or lower than N) loop filter 650-i includes a subtracter 421-i, a multiplier 422-i, an adder 623-i, a register circuit 630-i and a multiplexer 641-i. In addition, in general, a higher order N of the loop filter 650 enables more effective suppression of the folding noise. Moreover, more bits are required for the loop filters 650-i to represent various signals as the stage proceeds, so that, actually, the subtracters 421-i, the multipliers 422-i and the adders 623-i gradually increase in area.

The adder 623-1 in the first-stage loop filter 650-1 performs integration by adding the integrator input signal from the subtracter 421-1 to an integrator feedback signal from the multiplexer 641-1 described later. The adder 623-1 inputs the result of the addition to the register circuit 630-1 and to the subtracter 421-2 in the second-stage (subsequent stage) loop filter 650-2 as an integrated signal.

The register circuit 630-1 in the first-stage loop filter 650-1 includes a flip-flop 630-1-1 for temporarily holding the integrated signal associated with the input signal Input_1, a flip-flop 630-1-2 for temporarily holding the integrated signal associated with the input signal Input_2, . . . , and a flip-flop 630-1-M for temporarily holding the integrated signal associated with the input signal Input_M. Specifically, the M flip-flops 630-1-1 to 630-1-M are controlled one to one by the M control clocks φ1 to φM.

The common integrated signal from the adder 623-1 is input to the M flip-flops 630-1-1 to 630-1-M. At the rising of the control clock φ1, the integrated signal associated with the input signal Input_1 is input to the register circuit 630-1-1, and the flip-flop 630-1-1 holds this integrated signal. Then, the flip-flop 630-1-1 inputs this integrated signal to the multiplexer 641-1 until the next rising edge of the control clock φ1. At the rising of the other control clocks φ2 to φM, the integrated signals associated with the input signals Input_2 to Input_M are held by the flip-flops 630-1-2 to 630-1-M, respectively. Then, the flip-flops 630-1-2 to 630-1-M input these integrated signals to the multiplexer 641-1 until the next rising edges of the control clocks φ2 to φM.

The multiplexer 641-1 in the first-stage loop filter 650-1 selects one of the signals from the M flip-flops 630-1-1 to 630-1-M in the register circuit 630-1, and inputs the selected signal to the adder 623-1 as the integrator feedback signal. Specifically, the multiplexer 641-1 selects the signals from the M flip-flops 630-1-1 to 630-1-M in one-to-one correspondence with the M control clocks φ1 to φM.

The adder 623-j, the register circuit 630-j and the multiplexer 641-j in the j-th stage (j is a natural number equal to or higher than 2 and lower than N) loop filter 650-j are similar to the adder 623-1, the register circuit 630-1 and the multiplexer 641-1 that have been described above.

The multiplexer 641-N in the N-th stage loop filter 650-N selects one of the signals from the M flip-flops 630-N−1 to 630-N-M in the register circuit 630-N, and inputs the selected signal to the adder 623-N, the output discrimination circuit 510 and the interpolator 602 as the integrator feedback signal. Specifically, the multiplexer 641-N selects the signals from the M flip-flops 630-N−1 to 630-N-M in one-to-one correspondence with the M control clocks φ1 to φM.

The adder 623-N in the N-th stage loop filter 650-N is similar to the adders 623-1 and 623-j described above. Moreover, the register circuit 630-N in the N-th stage loop filter 650-N is similar to the register circuits 630-1 and 630-j described above.

The interpolator 602 performs interpolation in which “0” is inserted so that the sampling number of the integrator feedback signals from the multiplexer 641-N may be D times. Specifically, the interpolator 602 performs an AND operation between a control clock φINT having a sampling rate 1/D times as high as that of the control clocks φ1 to φM, and the integrator feedback signal, and the interpolator 602 then inputs the result of the operation to the multipliers 422-1 to 422-N as the feedback signal.

In the sample rate converter according to the present embodiment, the number of input signals and the order of the loop filter in the sample rate converter according to the third embodiment previously described are extended and generalized. Any value can be obtained for the order of the loop filter by the number of loop filters to be cascaded in FIG. 9. Moreover, any value can be obtained for the number of input signals in the sample rate converter by adjusting the number of flip-flops included in the register circuit and the output discrimination circuit in FIG. 9 and the operation speeds of the subtracters, the multipliers, the adders and the interpolator. Therefore, in the sample rate converter according to the present embodiment, the number of input signals can be any number, and an increase in the circuit area and power consumption due to the increase in the number of input signals can be inhibited.

Furthermore, the circuit areas of the subtracter, the multiplier and the adder included in each of the stages of the loop filter increase as the stage proceeds. On the other hand, in the sample rate converter according to the present embodiment, the subtracter, the multiplier and the adder can be shared by the respective stages of the loop filter regardless of the number of input signals, so that an increase in the circuit area and power consumption can be effectively inhibited particularly when a high-order loop filter is used.

Still further, in the sample rate converter according to the fourth embodiment previously described, the multiplexer 404 and the decimator 403 are used to provide the integrated signal one cycle before to the interpolator 402. However, in the sample rate converter according to the present embodiment, the integrator feedback signal from the multiplexer 641-N is the above-mentioned integrated signal one cycle before, so that this integrator feedback signal can be directly input to the interpolator 602. Therefore, the sample rate converter according to the present embodiment dispenses with the above-mentioned multiplexer 404 and decimator 403, and can thus have simpler circuits than in the fourth embodiment.

### Seventh Embodiment

A receiver according to a seventh embodiment of the invention has an antenna 701, a low noise amplifier (LNA) 702, a frequency converter 703, an analog-to-digital converter 704, a sample rate converter 705, a channel selection filter 706 and a demodulation/decode unit 707.

The antenna 701 receives a radio signal transmitted from an unshown transmitter, and inputs the received signal to the LNA 702. The LNA 702 amplifies the amplitude of the received signal from the antenna 701 at a predetermined gain, and inputs the signal to the frequency converter 703.

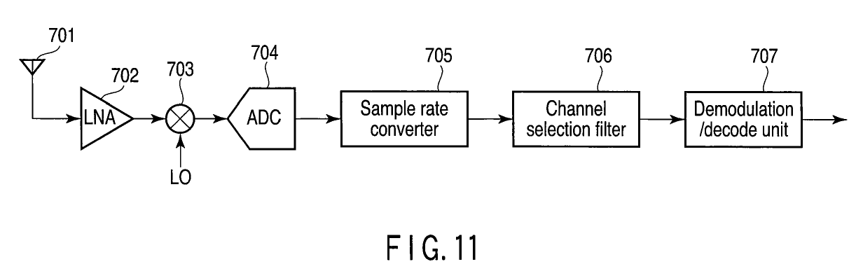

The frequency converter 703 includes a mixer and a low pass filter (LPF). The mixer in the frequency converter 703 multiplies the amplified received signal from the LNA 702 by a local signal LO for downconversion, and obtains a sum frequency component and a difference frequency component. The LPF in the frequency converter 703 only extracts the difference frequency component out of the sum frequency component and the difference frequency component, and inputs the difference frequency component to the analog-to-digital converter 704 as a reception baseband signal. In addition, although FIG. 11 shows the frequency converter 703 as only generating one reception baseband signal, the frequency converter 703 is capable of generating any number of reception baseband signals. The frequency converter 703 uses, for example, a phase shifter to generate a plurality of reception baseband signals different from each other in phase. For example, the frequency converter 703 may generate an I-channel signal and a Q-channel signal. Any number of reception baseband signals is assumed in the following explanation as well.

The analog-to-digital converter 704 is an oversampling A/D converter. The analog-to-digital converter 704 performs the analog-to-digital conversion of the reception baseband signal from the frequency converter 703 at a sample rate sufficiently higher than the frequency band of the reception baseband signal, and obtains a digital reception baseband signal. The analog-to-digital converter 704 inputs the digital reception baseband signal to the sample rate converter 705.

The sample rate converter 705 is a sample rate converter according to any one of the first to sixth embodiments described above. The sample rate converter 705 downsamples the sample rate of the digital reception baseband signal from the analog-to-digital converter 704 as a sample rate corresponding to the frequency band of the reception baseband signal. The sample rate converter 705 inputs the downsampled digital reception baseband signal to the channel selection filter 706.

The channel selection filter 706 removes interference waves out of the desired frequency band from the digital reception baseband signal coming from the sample rate converter 705, and inputs the digital reception baseband signal from which the interference waves have been removed to the demodulation/decode unit 707.

The demodulation/decode unit 707 demodulates the digital reception baseband signal from the channel selection filter 706 in accordance with a predetermined demodulation scheme. Further, the demodulation/decode unit 707 decodes the demodulated signal in accordance with a predetermined decoding scheme, and reproduces received data.

As described above, the receiver according to the present embodiment uses the sample rate converter according to any one of the first to sixth embodiments described above. Therefore, in the receiver according to the present embodiment, an increase in the area and power consumption of the sample rate converter due to the increase in the number of channels of received signals can be inhibited.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sample rate converter which converts a sample rate of a plurality of input signals to generate a plurality of output signals, comprising:
a first multiplexer which sequentially selects the plurality of input signals within a cycle corresponding to the sample rate and multiplexes the input signals to obtain a multiplexed input signal;
an interpolator which interpolates a multiplexed output signal in accordance with a decimation rate to generate a first feedback signal;
a multiplier which multiplies the first feedback signal by a coefficient to generate a multiplied signal;
a subtracter which subtracts the multiplied signal from the multiplexed input signal to generate a residual signal;
an adder which adds the residual signal and a second feedback signal to sequentially generate a plurality of integrated signals corresponding to the plurality of input signals, respectively;
a register circuit configured to individually hold the plurality of integrated signals;
a second multiplexer which sequentially selects the integrated signals from the register circuit and multiplexes the integrated signals to generate the second feedback signal;
a third multiplexer which sequentially selects the integrated signals from the register circuit and multiplexes the integrated signals to generate a decimation target signal;
a decimator which subjects the decimation target signal to decimation in accordance with the decimation rate to generate the multiplexed output signal; and
a discrimination circuit configured to discriminate the multiplexed output signal to generate the plurality of output signals.

2. The sample rate converter according to claim 1, wherein the plurality of input signals are an I-channel signal and a Q-channel signal.

3. The sample rate converter according to claim 1, wherein the register circuit includes the same number of flip-flops as the number of input signals, the plurality of integrated signals being commonly input to the respective flip-flops, the flip-flops individually holding the plurality of integrated signals corresponding to the plurality of input signals.

4. The sample rate converter according to claim 1, wherein the coefficient is determined by the decimation rate.

5. A sample rate converter which converts a sample rate of a plurality of input signals to generate a plurality of output signals, comprising:
a multiplexer which sequentially selects the plurality of input signals within a cycle corresponding to the sample rate and multiplexes the input signals to obtain a multiplexed input signal;
an interpolator which interpolates a multiplexed output signal in accordance with a decimation rate to generate a feedback signal;
a multiplier which multiplies the feedback signal by a coefficient to generate a multiplied signal;
a subtracter which subtracts the multiplied signal from the multiplexed input signal to generate a residual signal;
an adder which adds the residual signal and the multiplexed output signal to sequentially generate a plurality of integrated signals corresponding to the plurality of input signals, respectively;
a shift register circuit configured to hold the integrated signals and take the integrated signals out as the multiplexed output signal after the cycle has passed; and
an output discrimination circuit configured to discriminate the multiplexed output signal to generate the plurality of output signals.

6. The sample rate converter according to claim 5, wherein the plurality of input signals are an I-channel signal and a Q-channel signal.

7. The sample rate converter according to claim 5, wherein the shift register circuit includes the same number of cascaded flip-flops as the number of input signals, all of the flip-flops being controlled by a common control clock.

8. The sample rate converter according to claim 5, wherein the coefficient is determined by the decimation rate.

9. A sample rate converter which converts a sample rate of a plurality of input signals to generate a plurality of output signals, comprising:
a first multiplexer which sequentially selects the plurality of input signals within a cycle corresponding to the sample rate and multiplexes the input signals to obtain a multiplexed input signal;
an interpolator which interpolates a multiplexed output signal in accordance with a decimation rate to generate a feedback signal;
a multiplier which multiplies the feedback signal by a coefficient_to generate a multiplied signal;
a subtracter which subtracts the multiplied signal from the multiplexed input signal to generate a residual signal;
an adder which adds the residual signal and the multiplexed output signal to sequentially generate a plurality of integrated signals corresponding to the plurality of input signals, respectively;
a register circuit configured to individually hold the plurality of integrated signals;
a second multiplexer which sequentially selects the integrated signals from the register circuit and multiplexes the integrated signals to generate the multiplexed output signal; and
an output discrimination circuit configured to discriminate the multiplexed output signal to generate the plurality of output signals.

10. The sample rate converter according to claim 9, wherein the plurality of input signals are an I-channel signal and a Q-channel signal.

11. The sample rate converter according to claim 9, wherein the register circuit includes the same number of flip-flops as the number of input signals, the plurality of integrated signals being commonly input to the respective flip-flops, the flip-flops individually holding the plurality of integrated signals corresponding to the plurality of input signals.

12. The sample rate converter according to claim 9, wherein the coefficient is determined by the decimation rate.

13. A receiver comprising:
an amplifier which amplifies a received RF signal;
a frequency converter which down-converts the amplified RF signal to obtain a plurality of baseband signals different from each other in phase;
an analog-to-digital converter which converts the plurality of baseband signals to a plurality of digital baseband signals;
the sample rate converter according to claim 1 which accepts the plurality of digital baseband signals as the plurality of input signals and converts the sample rate to obtain the plurality of output signals;
a filter which performs filtering to removes interference waves from each of the plurality of output signals and generates filtered signals; and
a demodulation/decode unit configured to demodulate and decode the filtered signals to reproduce received data.
